(19) United States
(12) Patent Application Publication
(10) Pub. No.: US 2018/0116901 A1
(43) Pub. Date: May 3, 2018

(54) FLEXIBLE BACK SCRATCHER & BACK WASHING KIT

(71) Applicant: Katherine A. Brisendine, Laconia, NH (US)

(72) Inventor: Katherine A. Brisendine, Laconia, NH (US)

(21) Appl. No.: 15/339,234

(22) Filed: Oct. 31, 2016

(51) Int. Cl. A61H 7/00

(52) U.S. Cl. CPC A61H 7/005; A61H 2205/081; A61H 2201/1623; A61H 2201/1253; A61H 2201/1669

(57) ABSTRACT

A back scratcher including a flexible cord upon which a series of substantially flat, round discs and bead shaped spacers are strung in a sequence, and a back washer that includes the back scratcher and a removable sleeve.

### FIELD OF THE INVENTION

The present invention relates generally to back scratchers and washers and, more particularly, to flexible back scratchers and back washers.

### BACKGROUND

Owing to the difficulty of a person to contact areas of the upper and lower back portions of the body there have been previously proposed several back-scratching devices to facilitate the scratching of an itch on that portion of the body. Several back scratcher patents disclose wooden sticks bent on one end, wooden sticks with animal claws or antlers, a large metal hook device that reaches over the shoulder, wide leather straps with stiff bristle brushes, metal telescoping devices, shower wall or tub mounted bristle brushes along with mounted motor-driven brushes. Although the assemblies shown in these patents do accomplish their intended purpose, most are relatively extensive in size, may not be easily transported, with some requiring assembly and maintenance, are difficult for many people to use, especially those with a limited range of motion, and cannot be easily cleaned between uses. Most prior art back scratchers have fallen out of fashion because they were not easy to use and many caused unsolicited pain to the person.

In addition to scratching the back, there is a need to easily wash the back. Traditionally this has been through the use of long handled brushes, which are difficult for many people to use, especially those with a limited range of motion, do not dry properly and tend to promote the growth of mildew, and cannot be easily cleaned between uses.

Accordingly, there is a need for a back scratcher that is easy to use by people with a limited range of motion, is easily cleaned between uses, dries quickly and completely and does not promote the growth of mildew, is small in size and may be easily transported, and does not require assembly or maintenance.

### SUMMARY OF THE INVENTION

The present invention is a back scratcher and a back washing kit that overcome the drawbacks inherent in the prior art.

In its most basic form, the back scratcher of the present invention includes a substantially flexible central structural member having a length and a cross section, a plurality of substantially thin discs having a disc thickness and a disc periphery, a plurality of spacers having a spacer thickness and a spacer periphery, and paid of knots or other means for holding the spacers and the discs in a desired location along the length of the structural member. Each of the plurality of discs includes a disc center hole dimensioned to allow the cross section of the structural member to pass therethrough and each of the plurality of spacers includes a spacer center hole dimensioned to allow the cross section of the structural member to pass therethrough. The spacer thickness is greater than the disc thickness and a distance from the spacer center hole to the spacer periphery is less than a distance between from the disc center hole and the disc peripherty. The structural member is disposed through the disc center hole and the spacer center hole of each of the discs and spacers and the discs and spacers are disposed such that at least one spacer is disposed between at least two discs.

The back scratcher is provided by stringing onto a central structural member, preferably a flexible nylon cord, first a plastic spacer followed by a plastic disc, a spacer, a disc, and repeating this pattern to form a length of discs and spacers in a sequence. This series of discs and spacers equal to approximately one-third of the length of structural member and are positioned in the central area of the structural member by securing them in place with one overhand knot at the beginning of the series of discs and spacers and one overhand knot at the end, thus allowing a short length of structural member with enough to fashion a loop handle from the structural member on each end, creating a product having a greater length than width.

The back scratcher is designed to be used as such that the user holds one loop handle in one hand and the other loop handle in the other hand while the device is stretched over the back area and with the pulling of each hand at the wrist and minimal arm motion required, the flexible disc and spacer portion of the device is drawn over the back in side to side movement or up and down motions by raising one arm while lowering the other. This allows the arms to be in front of the body most of the time and at no time do the arms need to be extended to reach behind the back.

The back scratcher of the present invention is adapted to provide different levels of itch relief. This is done by cutting the plastic discs ranging from ½″ to 1″ diameter into smooth round circles for a gentle scratch or leaving the plastic discs rough-cut with pointed edges to deliver a more aggressive, deeper relief of the itch.

The back washing kit of the present invention includes the back scratcher and a flexible sleeve, which is preferably made of terry-cloth or other “washcloth” materials. The sleeve includes end closures that allow it be secured at both ends around the back scratcher when used and to be removed and dried after uses. In some embodiments, multiple sleeves are provided, while in others, the shape and material of the sleeve is varied. The kit allows a person to be capable of washing the complete body including neck, legs and feet. This is useful for people who are large, elderly or physically disabled.

Therefore, it is an aspect of the invention to provide a back scratcher that is easy to use by people with a limited range of motion.

It is a further aspect of the invention to provide a back scratcher and back washer kit that dries quickly and completely and does not promote the growth of mildew.

It is a further aspect of the invention to provide a back scratcher that is easily cleaned between uses.

It is a further aspect of the invention to provide a back scratcher that is small in size and may be easily transported.

It is a further aspect of the invention to provide a back scratcher that does not require assembly or maintenance.

It is a still further aspect of the invention to provide a back scratcher that provides greater effectiveness and comfort than conventional back scratchers.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a perspective view of a preferred embodiment of the back scratcher of the present invention.

FIG. 2A is a perspective view of the back scratcher assembly pattern for an embodiment in which the plastic disc are round and smooth.

FIG. 2B is a perspective view of the back scratcher assembly pattern for an embodiment in which the plastic disc are rough-cut with angled and not smooth edges.

FIG. 3A is a front and rear elevation view of a preferred embodiment of the back scratcher of the present invention using round smooth discs.

FIG. 3B is a front and rear elevation view of an embodiment of the back scratcher of the present invention using disc that are rough-cut with angled and not smooth edges.

FIG. 4A is a perspective view of a preferred embodiment of the back scratcher of the present invention being used to scratch horizontally over a back.

FIG. 4B is a perspective view of a preferred embodiment of the back scratcher of the present invention being used to scratch at a vertical angle over a back.

FIG. 5A is a perspective view of the sleeve of the back washing kit showing it as folded in half lengthwise and stitched along the length.

FIG. 5B is a perspective view of the sleeve of the back washing kit after stitching.

FIG. 5C is a perspective view of the sleeve of the back washing kit positioned over the back scratcher with the cord exiting through the opening.

FIG. 5D is a perspective view of the sleeve of the back washing kit positioned over the back scratcher with the cord pulled tightly to cinch the fabric sleeve securely in place.

FIG. 6A is a perspective view of a preferred embodiment of the assembled back washing kit of the present invention being used to wash horizontally over a back.

FIG. 6B is a perspective view of a preferred embodiment of the assembled back washing kit of the present invention being used to wash at a vertical angle over a back.

### DETAILED DESCRIPTION

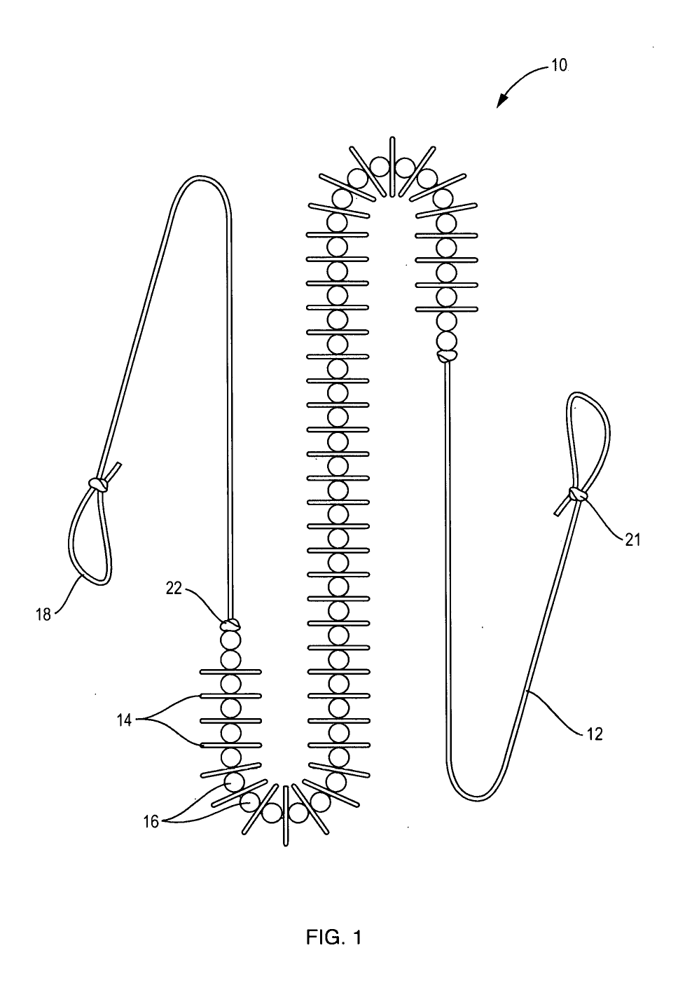

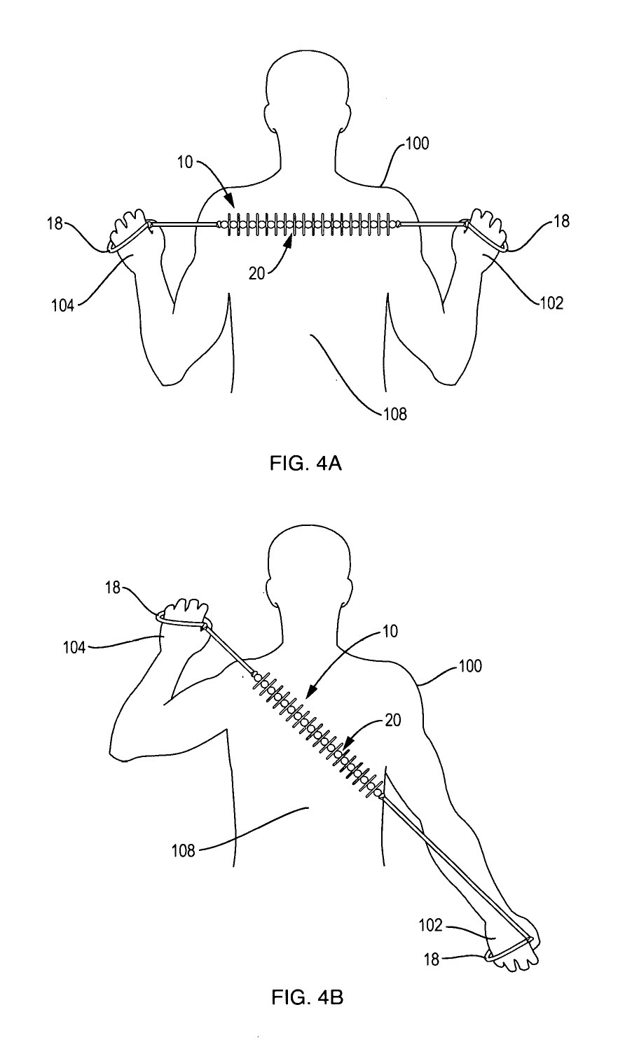

The present invention is a different approach to previous back scratchers. As shown in FIG. 1, the back scratcher 10 is provided by using a flexible central structural member 12 and stringing a series of round, flat, plastic discs 14 and plastic spacers 16 in a sequence to form a disc and spacer portion 20. When the back scratcher 10 is pulled over the back, the disc and spacer portion 20 is usable as a scratcher as shown in FIGS. 4A and 4B.

The central structural member 12 of the back scratcher 10 is preferably an elongated main piece of flexible ⅛″ diameter braided nylon cord 12. Flexible braided cord is the preferred material for the structural member 12 as it allows the device to contour to the surface of the back. The central structural member 12 may be made of nylon, cotton, polyester, leather, and the like, as long as it provides a flexible, durable, strong material especially capable of withstanding high tensile forces. Preferably, the material is to be 3 mm thick, 100% nylon lightweight kernmantle rope with a 325 pound tensile strength. Nylon is easy to wash, dries quickly, won't rot, mildew or fade to UV. It is also noted the use of 325 para-cord allows for the back scratcher 10 to be stored in a compact state, as it folds into a small 3″×5″ size, for easy storage or transporting.

It is preferred that each end of the central structural member 12 is provided with a loop that serves as a handle 18 by which a person may grip the product. It is noted that the length of cord for the handle 18 is approximately 8″ and folded back onto the cord and attached to form a 4″ loop handle 18. Preferably, the end of the cord is attached to the cord by sewing with thread to assure attachment. A single overhand knot 20 is preferably applied over the stitching to assure added durability. Although loops 18 are preferred, it is recognized that other types of handles known in the art may be substituted to achieve similar results.

As shown in FIGS. 4A and 4B, the user 100 holds one loop handle 18 in one hand 102 and the other loop handle 18 in the other hand 104 while the device is stretched over the back area 108 and with the pulling of each hand 102, 104 at the wrist and minimal arm motion required, the flexible disc and spacer portion 20 of the back scratcher 10 is drawn over the back 108 in side to side movement, as shown in FIG. 4A, or up and down motions by raising one arm while lowering the other as shown in FIG. 4B. In the preferred embodiment the width of the disc and spacer portion 20 is one inch, with its length between three and four feet having a length sufficient for scratching the back while maintaining the arms in front of the body. However, the ratio of length can be varied depending upon the requirements of the ultimate consumer.

As shown in FIGS. 1, 2A, 2B, 3A and 3B the assembly begins with first crafting the loop handle 18 on one end of the structural member 12 leaving the other end to thread the spacers 16 and discs 14. Second, the spacers 16 and discs 14 are strung in the repeated pattern to the desired length. Third, the second handle 18 is crafted on the remaining end of the structural member 12. Last, the spacers 16 and discs 14 are centered to the middle of the structural member 12 and an overhand knot 22 is used on each end of the disc and spacer portion 20 to hold them in place. However, in some embodiments, clips, crimps or other art recognized means for holding the spacers 16 and discs 14 in place are substituted for the overhand knots 22.

The discs 14 are preferably pieces of plastic 0.01 mm thick that are cut such that their periphery approximates circles ranging in size from ½″ to 1″ diameter. The plastic discs retain their shape, are waterproof and washable. Preferably, the material is to be without color, but colored plastic or other materials may be used.

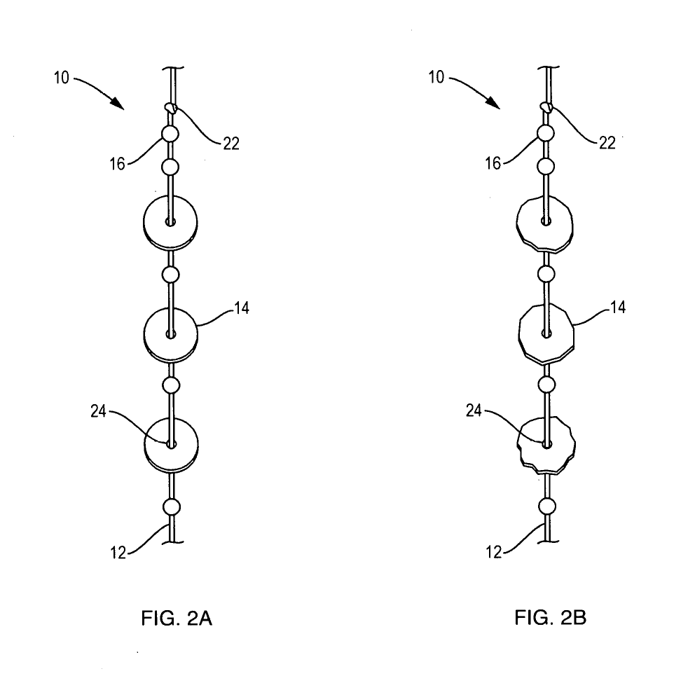

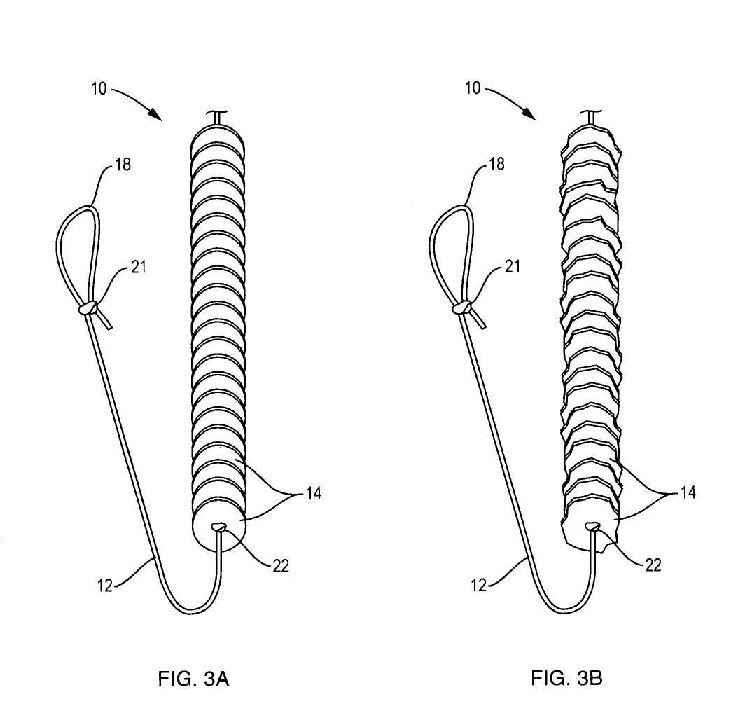

The thickness of some discs 14 varies slightly within 0.01 and 0.02 mm. It will be noted the diameter of the discs 14 are varied, some extend more than others causing the edges of the discs 14 to be at varied heights creating an uneven outer diameter of discs a4. In the embodiment of FIGS. 2A and 3A, the discs 14 are cut round and smooth, which generates a gentle scratch. In the embodiment of FIGS. 2B and 3B, the discs 14 are rough-cut with angled edges to generate a more aggressive scratch. Both applications are effective to access all areas of the back and provide different levels of scratching sensation to achieve itch relief in large areas at one time.

As shown in FIGS. 2A and 2B, each disc 14 has a disc center hole 24 having a diameter of approximately ⅛″, which allows the braided cord to be threaded through the disc and allows the disc to spin on the cord when in use and pressure is applied. This is preferred as it will not tear the skin but easily roll into a different position and the rolling motion is a unique aspect of the present invention.

The spacers 16 have a spacer periphery that is smaller than the disc periphery such that the discs 14 extend past the spacers 16. Spacers 16 may be made of plastic, glass, crystal, wood, metal, and the like, as long as it provides a durable, strong material. Preferably, the material is to be ¼″ plastic as it does not shatter, splinter or rot, is easily washable, dries quickly and will not rot or mildew.

Each back scratcher 10 is unique; the numerous color combinations of the spacers 16 add visual appeal. The discs 14 are not all the same size or perfectly round or perfectly centered on the structural member 12. The overall length of the back scratcher 10 depends on the size of the person using it. No two are exactly the same in appearance, but all perform the exact same function in application. While a specific embodiment of the invention has been shown and described, it is to be understood that numerous changes and modifications may be made therein without departing from the scope, spirit and intent of the invention as set forth in the appended claims.

The kit of the present invention includes the back scratcher 10 and at least one flexible sleeve 50 that is designed to be secured over the disc and spacer portion 20 of the back scratcher 10 to allow it be used as a back washer. The back washer kit preferably includes a terry-cloth sleeve 50, a “washcloth” over the backscratcher allowing for a body washer and massager. This allows a person to be capable of washing the complete body including neck, legs and feet. This is useful for people who are large, elderly or physically disabled.

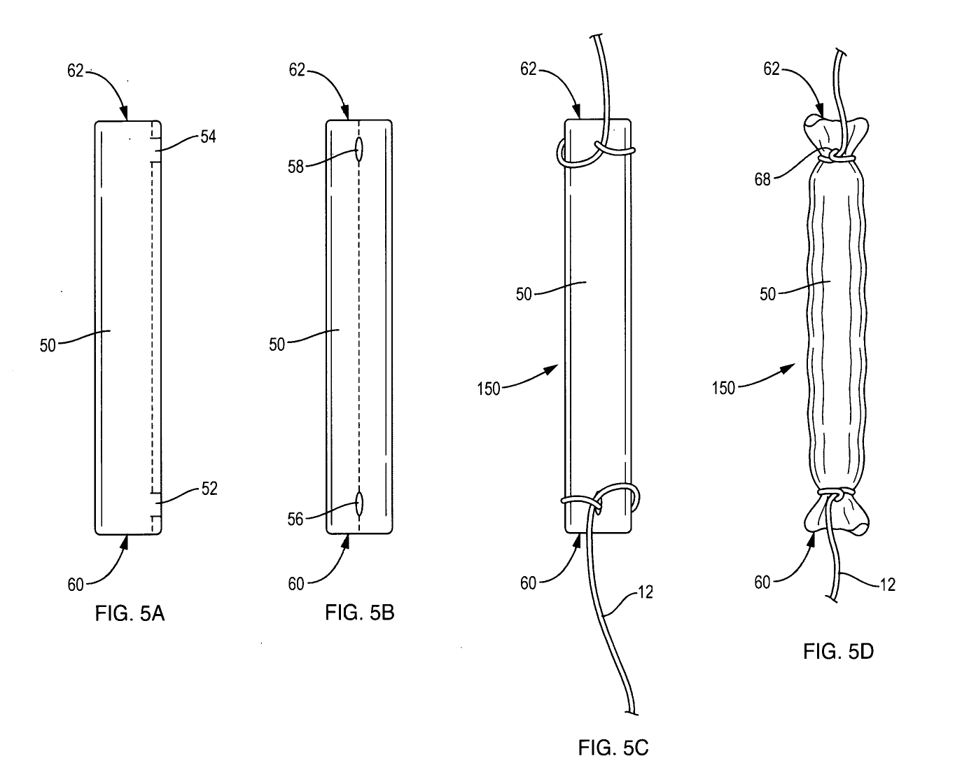

FIG. 5A-5D show the design of the sleeve 50, which preferably begins as a rectangular piece of fabric folded in half lengthwise and stitched along the length to create a sleeve. Two small sections 52, 54 are not stitched on each end to create button hole openings 56, 58 shown in FIG. 5B. Button hole openings 56, 58 are preferably ¾″ openings placed 1″ from each end 60, 62 of the sleeve.

FIG. 5C shows the partially assembled kit 150 with sleeve 50 in position over the spacer and disc portion of the back scratcher with the structural member 12 exiting through the button hole openings 56, 58, wrapping around the sleeve 50, joining with the structural member 12 at each opening 56, 58 and pushed under the first section of cord to form a loose knot 58 over the fabric. FIG. 5D shows the structural member 12 with the knot 68 pulled tightly to cinch the ends 60, 62 of the sleeve 50 securely in place.

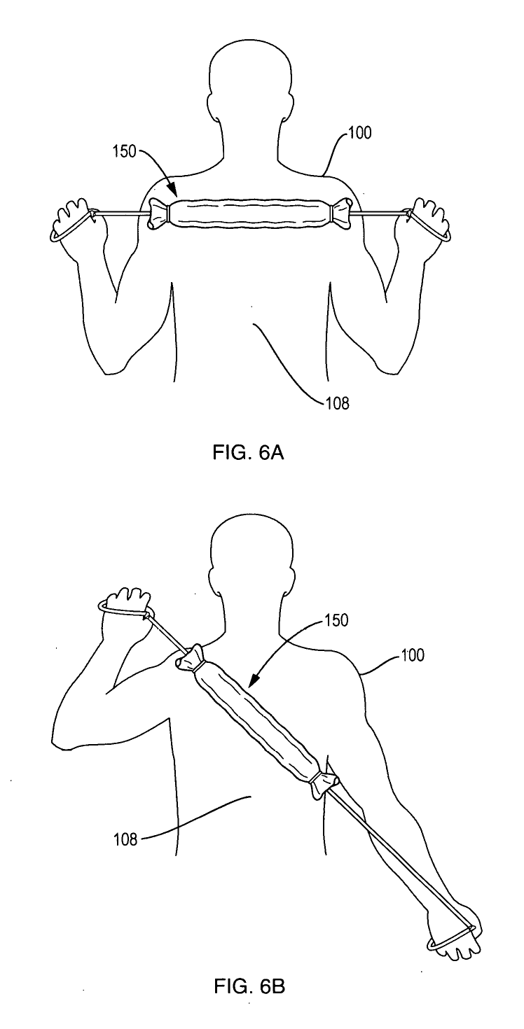

FIGS. 6A and 6B show the assembled kit 150 in use as a back washer, with FIG. 6A showing the kit being used horizontally over the back 108 of a user and FIG. 6B showing the kit being used at a vertical angle over the back 108 of the user 100.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A back scratcher comprising:
a substantially flexible central structural member having a length and a cross section;
a plurality of substantially thin discs having a disc thickness and a disc periphery, wherein each of said plurality of discs comprises a disc center hole dimensioned to allow said cross section of said structural member to pass therethrough;
a plurality of spacers having a spacer thickness and a spacer periphery, wherein each of said plurality of spacers comprises a spacer center hole dimensioned to allow said cross section of said structural member to pass therethrough, wherein said spacer thickness is greater than said disc thickness and wherein a distance from said spacer center hole to said spacer periphery is less than a distance between from said disc center hole and said disc peripherty; and
a means for holding said spacers and said discs in a desired location along said length of said structural member;
wherein said structural member is disposed through said disc center hole and said spacer center hole of each of said plurality of discs and said plurality of spacers; and
wherein said plurality of discs and said plurality of spacers are disposed such that at least one spacer is disposed between at least two discs.

2. The back scratcher as claimed in claim 1 wherein said substantially flexible central structural member has a substantially circular cross section.

3. The back scratcher as claimed in claim 2 wherein said substantially flexible central structural member is a nylon cord and said circular cross section has a diameter of 0.125 inches.

4. The back scratcher as claimed in claim 1 further comprising a handle disposed at each end of said length of said substantially flexible central structural member.

5. The back scratcher as claimed in claim 4 wherein at least one handle comprises a loop formed from said substantially flexible central structural member.

6. The back scratcher as claimed in claim 1 wherein said periphery of at least one of said plurality of substantially thin discs defines a circle.

7. The back scratcher as claimed in claim 6 wherein said periphery of at least one of said plurality of substantially thin discs defines a circle having a diameter of between 0.5 inches and 1 inch.

8. The back scratcher as claimed in claim 1 wherein said periphery of at least one of said plurality of substantially thin discs comprises a plurality of angled edges.

9. The back scratcher as claimed in claim 1 wherein each of said plurality of substantially thin discs has a disc center hole dimensioned to allow each disc to rotate about said central structural member.

10. The back scratcher as claimed in claim 1 wherein at least one of said a plurality of spacers is a plastic bead having a spacer thickness of between 0.125 inches and 0.25 inches.

11. The back scratcher as claimed in claim 1 wherein said means for holding said spacers and said discs in a desired location along said length of said structural member comprises a pair of knots formed in said structural member at locations along said length of said structural member.

12. The back scratcher as claimed in claim 1 wherein said plurality of discs and said plurality of spacers are disposed adjacent to each disc.

13. The back scratcher as claimed in claim 1 wherein each of said discs has a substantially equal disc thickness and a substantially different disc periphery.

14. The back scratcher as claimed in claim 1 wherein said plurality of discs and said plurality of spacers are disposed such that discs and spacers are disposed along at least one third of the length of said structural member.

15. A back scratcher comprising:
a substantially flexible central structural member having a length, a substantially circular cross section, a loop formed at each end thereof, and a pair of knots disposed along the length thereof between said loops;
a plurality of substantially thin discs having a disc thickness and a disc periphery, wherein each of said plurality of discs comprises a disc center hole dimensioned to allow said cross section of said structural member to pass therethrough; and
a plurality of spacers having a spacer thickness and a spacer periphery, wherein each of said plurality of spacers comprises a spacer center hole dimensioned to allow said cross section of said structural member to pass therethrough, wherein said spacer thickness is greater than said disc thickness and wherein a distance from said spacer center hole to said spacer periphery is less than a distance between from said disc center hole and said disc peripherty;
wherein said structural member is disposed through said disc center hole and said spacer center hole of each of said plurality of discs and said plurality of spacers; and
wherein said plurality of discs and said plurality of spacers are disposed such that at least one spacer is disposed adjacent to each disc; and
wherein said plurality of discs and said plurality of spacers are disposed along said length of said structural member between said pair of knots.

16. A back washing kit comprising;
a back scratcher comprising:
a substantially flexible central structural member having a length, a substantially circular cross section, a loop formed at each end thereof, and a pair of knots disposed along the length thereof between said loops;
a plurality of substantially thin discs having a disc thickness and a disc periphery, wherein each of said plurality of discs comprises a disc center hole dimensioned to allow said cross section of said structural member to pass therethrough; and
a plurality of spacers having a spacer thickness and a spacer periphery, wherein each of said plurality of spacers comprises a spacer center hole dimensioned to allow said cross section of said structural member to pass therethrough, wherein said spacer thickness is greater than said disc thickness and wherein a distance from said spacer center hole to said spacer periphery is less than a distance between from said disc center hole and said disc peripherty;
wherein said structural member is disposed through said disc center hole and said spacer center hole of each of said plurality of discs and said plurality of spacers; and
wherein said plurality of discs and said plurality of spacers are disposed such that at least one spacer is disposed adjacent to each discs; and
wherein said plurality of discs and said plurality of spacers are disposed along said length of said structural member between said pair of knot; and
at least one flexible sleeve comprising a length, a central opening dimensioned to allow said spacers of said back scratcher to pass therethrough, and a means for securing said flexible sleeve to said back scratcher.

17. The kit as claimed in claim 16 wherein said a means for securing said flexible sleeve to said back scratcher comprises an button hole opening in each end of said sleeve dimensioned to allow said structural member of said back scratcher to pass therethrough.

18. The kit as claimed in claim 16 wherein said at least one flexible sleeve comprises at least two flexible sleeves.

19. The kit as claimed in claim 16 wherein said at least one flexible sleeve is manufactured from a washable cloth material.
